(19) United States
(12) Patent Application Publication
(10) Pub. No.: US 2026/0323321 A1
(43) Pub. Date: Oct. 15, 2026

(54) BEHAVIORAL SEQUENCE MODELING FOR PREDICTIVE CLIENT ANOMALY DETECTION IN WIRELESS NETWORKS

(71) Applicant: Cisco Technology, Inc., San Jose, CA (US)

(72) Inventors: Peiman Amini, Fremont, CA (US); Ardalan Alizadeh, Milpitas, CA (US); Jerome Henry, Pittsboro, NC (US)

(21) Appl. No.: 19/408,698

(22) Filed: Dec. 4, 2025

Related U.S. Application Data
(60) Provisional application No. 63/878,722, filed on Sep. 9, 2025.

(51) Int. Cl. H04W 24/04; G06F 11/07; G06F 40/284; G06N 3/098; H04W 24/08

(52) U.S. Cl. CPC H04W 24/04; G06F 11/079; G06F 40/284; G06N 3/098; H04W 24/08

(57) ABSTRACT

According to one or more embodiments of the disclosure, the techniques herein provide behavioral sequence modeling for predictive client anomaly detection in wireless networks. In one embodiment, an illustrative method herein may comprise: determining, by a device, a sequence of client interaction events associated with communication between a wireless access point and a client device; tokenizing, by the device, the sequence of client interaction events into behavioral tokens comprising protocol-state, timing, and radio-parameter representations; processing, by the device, the behavioral tokens using a transformer-based sequence model to generate a sequence-likelihood output; and detecting, by the device, an anomaly or predicted future anomaly trajectory based on the sequence-likelihood output.

### RELATED APPLICATION

This application claims priority to U.S. Provisional Patent Appl. Ser. No. 63/787,722, filed on Sep. 9, 2025, entitled “BEHAVIORAL SEQUENCE MODELING FOR PREDICTIVE CLIENT ANOMALY DETECTION IN WIRELESS NETWORKS” by Ardalan Alizadeh, et al., the contents of which are incorporated by reference herein.

### TECHNICAL FIELD

The present disclosure relates generally to computer networks, and, more particularly, to behavioral sequence modeling for predictive client anomaly detection in wireless networks.

### BACKGROUND

Wireless networks in enterprise environments increasingly support diverse client devices including laptops, smartphones, tablets, IoT sensors, and specialized equipment. Each device exhibits unique behavioral patterns in terms of transmission timing, power save modes, protocol interactions, and application requirements. However, current anomaly detection systems deployed in wireless access points (APs) primarily rely on instantaneous metrics or threshold-based statistics that lack sequential and contextual awareness.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example high-level flowchart of behavioral sequence modeling and anomaly detection;

FIG. 4 illustrates an example behavioral-sequence processing pipeline implemented within an access point; and

FIG. 5 illustrates an example simplified procedure for behavioral sequence modeling for predictive client anomaly detection in wireless networks in accordance with one or more embodiments described herein.

### DESCRIPTION OF EXAMPLE EMBODIMENTS

### Overview

According to one or more embodiments of the disclosure, the techniques herein provide behavioral sequence modeling for predictive client anomaly detection in wireless networks. In one embodiment, an illustrative method herein may comprise: determining, by a device, a sequence of client interaction events associated with communication between a wireless access point and a client device; tokenizing, by the device, the sequence of client interaction events into behavioral tokens comprising protocol-state, timing, and radio-parameter representations; processing, by the device, the behavioral tokens using a transformer-based sequence model to generate a sequence-likelihood output; and detecting, by the device, an anomaly or predicted future anomaly trajectory based on the sequence-likelihood output.

Additionally, the techniques described herein may be performed by a system and/or device, which may have non-transitory computer-readable media storing computer-executable instructions that, when executed by one or more processors, performs the method described above.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

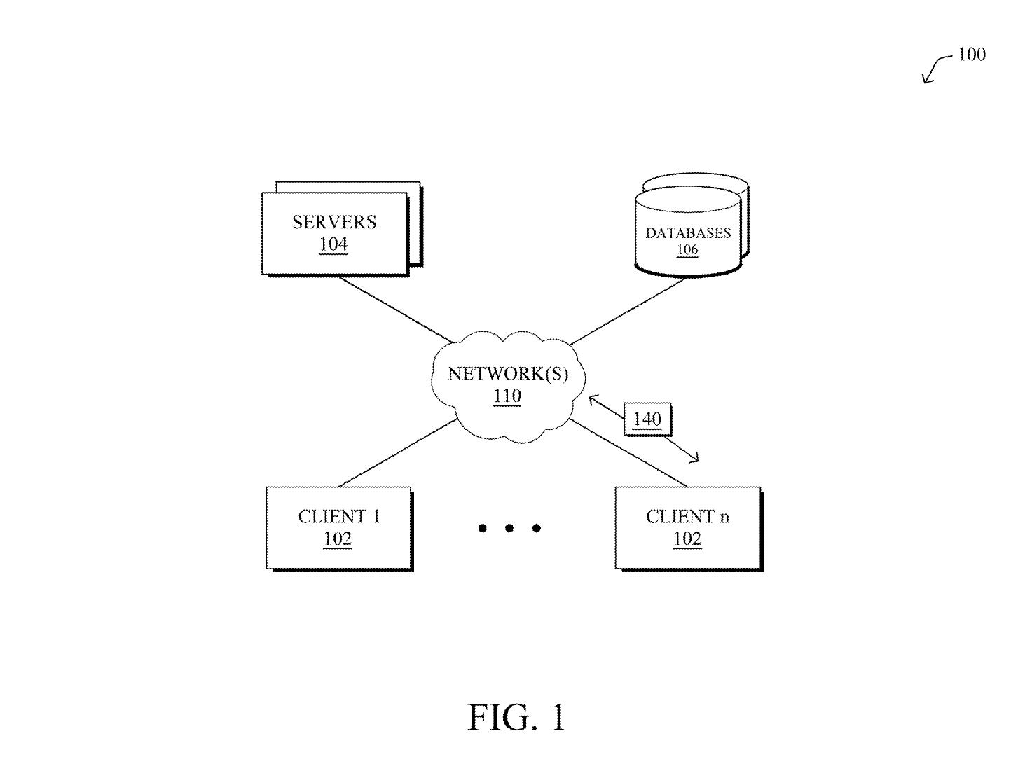

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Network(s) 110 may include, for example, network backbones or other internetworking systems, and may include various customer edge (CE) routers interconnected with provider edge (PE) routers in order to communicate across a core network to provide connectivity between devices which may be located in different geographical areas and/or on different types of local networks (e.g., local/branch networks versus data center/cloud environments). For example, these routers may be interconnected by the public Internet, a multiprotocol label switching (MPLS) virtual private network (VPN), or the like. In some implementations, a router or a set of routers may be connected to a private network (e.g., dedicated leased lines, an optical network, etc.) or a VPN (e.g., MPLS VPN) thanks to a carrier network, via one or more links exhibiting different network and service level agreement characteristics.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly. For instance, servers 104 may include, in various implementations, a network management server (NMS), a dynamic host configuration protocol (DHCP) server, a constrained application protocol (CoAP) server, an outage management system (OMS), an application policy infrastructure controller (APIC), an application server, etc.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

For instance, smart object networks, such as sensor networks, in particular, are a specific type of network (e.g., computing system 100) having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Generally, size and cost constraints on smart object nodes (e.g., sensors) result in corresponding constraints on resources such as energy, memory, computational speed and bandwidth.

In some implementations, the techniques herein may be applied to still other network topologies and configurations. For example, the techniques herein may be applied to peering points with high-speed links, data centers, etc.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user’s data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

According to various implementations, a software-defined WAN (SD-WAN) may be used in computing system 100 to connect local networks and data center/cloud environments. In general, an SD-WAN uses a software defined networking (SDN)-based approach to instantiate tunnels on top of the physical network and control routing decisions, accordingly. For example, one tunnel may connect a customer edge (CE) router at the edge of a local network to a remote CE router at the edge of a data center/cloud environment over an MPLS or Internet-based service provider network in a network backbone. Similarly, a second tunnel may also connect these routers over a 4G/5G/LTE cellular service provider network. SD-WAN techniques allow the WAN functions to be virtualized, essentially forming a virtual connection between local networks and data center/cloud environments on top of the various underlying connections. Another feature of SD-WAN is centralized management by a supervisory service that can monitor and adjust the various connections, as needed.

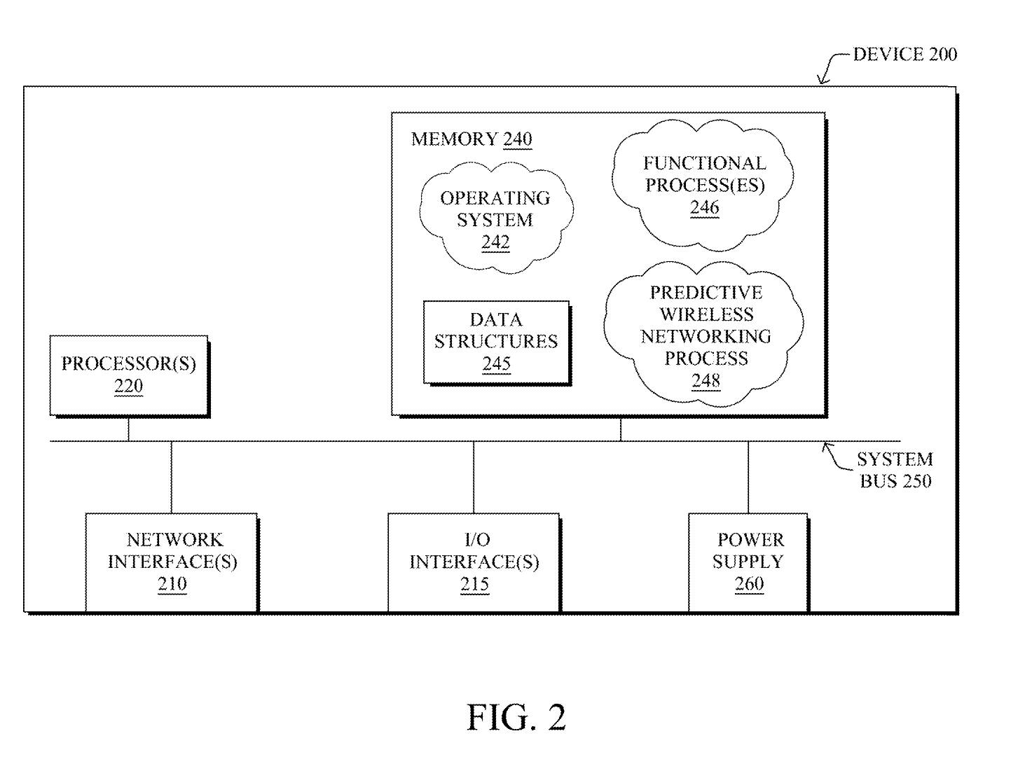

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, a predictive wireless networking process (process 248), as described herein, each of which may alternatively be located within individual network interfaces.

Notably, one or more functional processes 246, when executed by processor(s) 220, cause each device 200 to perform the various functions corresponding to the particular device’s purpose and general configuration. For example, a router would be configured to operate as a router, a server would be configured to operate as a server, an access point (or gateway) would be configured to operate as an access point (or gateway), a client device would be configured to operate as a client device, and so on.

For instance, one or more functional processes 246 may include computer executable instructions executed by the processor(s) 220 to perform routing functions in conjunction with one or more routing protocols. These functions may, on capable devices, be configured to manage a routing/forwarding table (of data structures 245) containing, e.g., data used to make routing/forwarding decisions, as well as neighbor lists, client association lists, and other various functions relating to access point behavior in particular.

In various implementations, as detailed further below, one or more functional processes 246 and/or predictive wireless networking process (process 248) may include computer executable instructions that, when executed by processor(s) 220, cause device 200 to perform the techniques described herein. To do so, in some implementations, one or more functional processes 246 and/or process 248 may utilize machine learning. In general, machine learning is concerned with the design and the development of techniques that take as input empirical data (such as network statistics and performance indicators) and recognize complex patterns in these data. In various implementations, one or more functional processes 246 and/or process 248 may employ one or more supervised, unsupervised, or semi-supervised machine learning models.

Example machine learning techniques that one or more functional processes 246 and/or process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, one or more functional processes 246 and/or process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, one or more functional processes 246 and/or process 248 may use a generative model to generate synthetic network traffic based on existing user traffic to test how the network reacts. Example generative approaches can include, but are not limited to, generative adversarial networks (GANs), large language models (LLMs), other transformer models, and the like. In some instances, one or more functional processes 246 and/or process 248 may be executed to intelligently route LLM workloads across executing nodes (e.g., communicatively connected GPUs clustered into domains).

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

Behavioral Sequence Modeling for Predictive Client Anomaly Detection

As noted above, current APs lack the ability to understand the sequential and contextual nature of client behavior patterns. Current anomaly detection systems operate on instantaneous metrics or sliding window statistics, missing the critical temporal dependencies that characterize client-AP interactions. When a client experiences service degradation, these systems detect symptoms like increased retransmissions or authentication failures, but cannot model the complex sequence of events that led to the failure state. This reactive approach results in late interventions, poor root cause identification, and an inability to predict failures before they impact user experience. That is, existing systems typically detect anomalies only after severe service degradation occurs, such as high retransmission rates or repeated authentication failures. These systems fail to capture the complex sequence of events leading to the failure, preventing proactive intervention.

Enterprise wireless environments compound this challenge through device heterogeneity and dynamic behavioral patterns. A video conferencing laptop exhibits fundamentally different communication patterns than an IoT sensor or mobile phone, yet current systems either apply uniform threshold-based rules or require extensive manual configuration for each device type. The lack of behavioral understanding means access points cannot distinguish between legitimate adaptation (client switching to power save mode during idle periods) and service degradation (client stuck in authentication loops), leading to false positives that overwhelm administrators and missed anomalies that only surface as user complaints.

The absence of temporal modeling further hinders predictive capabilities. While some anomalies emerge suddenly, others evolve gradually across sequences of client-AP interactions. Without capturing these temporal dependencies, existing systems remain reactive, provide limited root cause analysis, and fail to prevent user experience degradation before disconnection or service disruption occurs.

The techniques herein, therefore, provide a system that embeds neural language models in wireless (e.g., WiFi®) access points (APs) to learn and predict client behavioral sequences, treating client-AP interactions as tokens in a behavioral language processed through transformer attention mechanisms. The system uses self-supervised learning with protocol-aware masking to detect anomalies through sequence likelihood analysis, employing multi-scale temporal attention to capture patterns from microsecond protocol interactions to minute-scale application behaviors. Unlike traditional threshold-based detection that only sees symptoms, this approach predicts failure trajectories by understanding the sequential behavioral patterns leading to service degradation, enabling proactive intervention before client disconnections occur.

Said differently, the techniques herein introduce a behavioral sequence modeling system for wireless access points that employs neural language models to represent and analyze client-AP interaction sequences as a behavioral language. Each client interaction (e.g., association requests, data transmissions, acknowledgments, authentication states, and power save transitions), may be tokenized into a multi-dimensional embedding capturing action type, timing, radio parameters, and protocol state. A transformer-based attention mechanism may process these sequences across multiple temporal scales (e.g., microsecond, millisecond, and minute intervals), enabling the model to learn normal behavioral grammars through self-supervised masked token prediction. Anomalies may be detected as statistically unlikely sequences using metrics such as conditional token probability, attention entropy, and perplexity gradients.

As described in greater detail below, the techniques herein further include anomaly trajectory prediction through conditional sequence generation, which enables proactive intervention before service degradation reaches user-visible levels. The techniques herein also support cross-client behavioral transfer, allowing learned behavioral patterns to be applied to new clients using attention-based similarity metrics for rapid adaptation without retraining. Additionally, federated learning across access points improves the accuracy and robustness of behavioral models while preserving client privacy through privacy-preserving data aggregation techniques. The use of multi-scale temporal attention ensures that both local protocol events and long-range application behaviors are effectively captured within a unified modeling framework. Collectively, the techniques herein transform anomaly detection from a reactive, threshold-based mechanism into a predictive, context-aware system that enhances user experience, reduces false positives, and accelerates root cause identification.

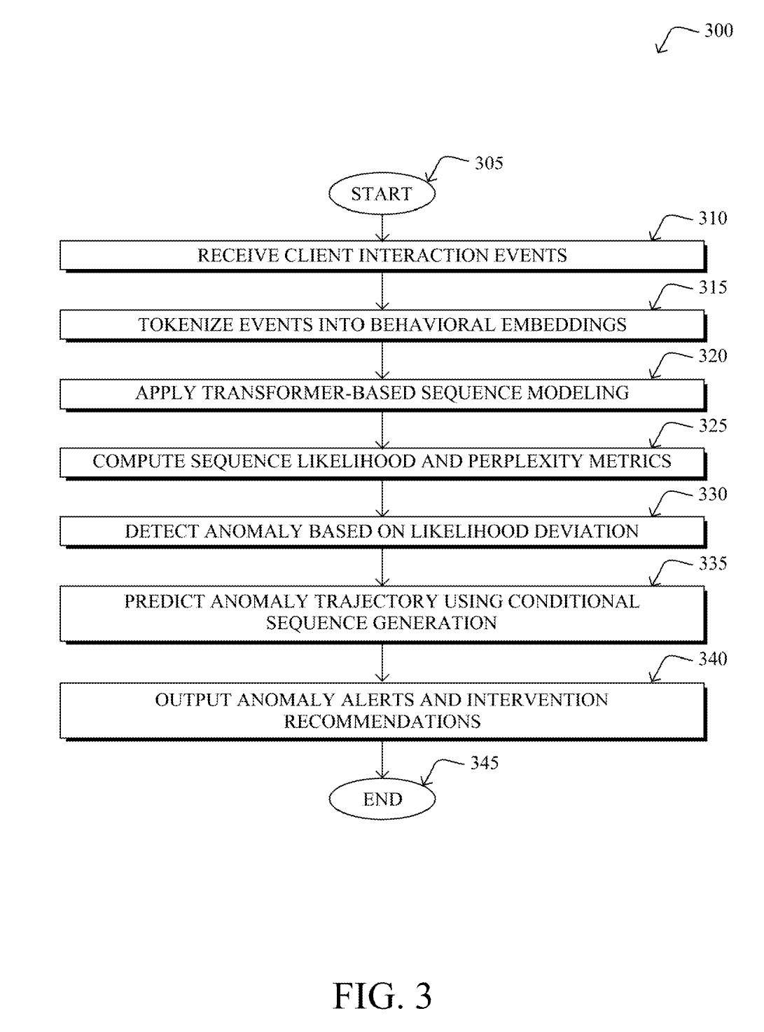

FIG. 3 illustrates an example simplified procedure (procedure 300) for behavioral sequence modeling and anomaly detection. A device (e.g., an access point) may perform the procedure (e.g., a method), which starts in step 305, and continues through the following illustrative steps, as described in greater detail herein:

Step 310: Receive client interaction events.

Step 315: Tokenize events into behavioral embeddings.

Step 320: Apply transformer-based sequence modeling.

Step 325: Compute sequence likelihood and perplexity metrics.

Step 330: Detect anomaly based on likelihood deviation.

Step 335: Predict anomaly trajectory using conditional sequence generation.

Step 340: Output anomaly alerts and intervention recommendations.

The procedure may then end in step 345, with the notable option to repeat and/or revisit any of the steps listed above.

For instance, the process begins at step 305, and then at step 310 the wireless access point collects client interaction events in real time. In step 315, these raw events are transformed into behavioral embeddings encoding action type, timing, radio characteristics, and protocol states. Step 320 applies a transformer-based neural network to model sequential dependencies across the behavioral tokens. At step 325, sequence likelihood metrics, including conditional probabilities and attention entropy, are computed. Step 330 detects anomalies when likelihood metrics deviate from normal behavioral baselines. Step 335 predicts potential failure trajectories using conditional sequence generation to simulate likely future interactions. Finally, step 340 outputs anomaly alerts and suggested interventions to network administrators or automated control systems, and the process ends in step 345.

Operationally, that is, and still as described in greater detail below, the system begins by continuously capturing client-AP interaction events, including association requests, authentication exchanges, data transmissions, acknowledgments, retransmissions, and power-save transitions. These events are tokenized into multi-dimensional embeddings representing action type, timing intervals, radio parameters, and protocol states.

The transformer-based attention model processes these embeddings across multiple temporal resolutions using hierarchical attention layers. Micro-attention layers capture fine-grained protocol events, meso-attention layers model mid-range behaviors like retransmission sequences, and macro-attention layers capture long-range application patterns such as idle periods or periodic traffic bursts.

Through self-supervised learning with protocol-aware masking, the model learns normal behavioral grammars without requiring labeled data. It computes sequence likelihood metrics, including perplexity and attention entropy, to detect anomalous deviations from learned norms. Perplexity gradients identify whether anomalies emerge abruptly or progressively, aiding in root cause classification.

The system extends beyond detection by performing anomaly trajectory prediction through conditional sequence generation. Given partial sequences exhibiting anomalous patterns, the model generates possible continuations ranked by likelihood, enabling proactive interventions before client disconnections occur.

Additionally, the system supports cross-client behavioral transfer, allowing knowledge learned from prior clients to inform anomaly detection for new devices based on behavioral similarity metrics. Federated learning mechanisms aggregate behavioral patterns across multiple access points while preserving client privacy through differential privacy transformations.

Now described in greater detail, consider a typical enterprise scenario: An executive's laptop intermittently fails during critical video calls. Traditional monitoring shows normal signal strength (-65 dBm) and low channel utilization (30%). However, the issue stems from a complex behavioral pattern: the laptop's driver enters power save mode after 800ms of silence, takes 15ms to wake, but the video application expects 10ms response times. This causes increasing buffer delays that cascade into connection drops after 3-4 minutes. Current systems see only the final disconnect, not the behavioral sequence leading to failure.

The techniques herein propose a system that embeds a neural language model within the wireless access point’s processing engine to model and predict client behavioral sequences using a learned behavioral language derived from access point log data. Rather than treating individual client-access point interactions as isolated metrics, the system represents each action in the client lifecycle as a token within a structured sequence. These tokenized sequences are then processed through transformer-based attention mechanisms, enabling the access point to construct rich representations of normal behavioral patterns and to identify deviations that signify anomalies or predicted future anomalies.

In operation, the system performs behavioral sequence tokenization by converting raw client interactions into discrete tokens using a multi-dimensional embedding scheme. Each client action (e.g., an association request, data transmission, acknowledgment, or rate-adaptation event, etc.) may be transformed into a fixed-dimensional vector that captures multiple aspects of the event, including an action-type embedding that encodes frame types and management actions, a timing embedding that represents inter-frame spacing and duration patterns, a radio-parameter embedding that captures modulation schemes, spatial streams, and transmit power levels, and a protocol-state embedding that represents power-save modes, aggregation states, and protection-mechanism transitions. A key aspect of this tokenization is the preservation of temporal causality. Where conventional approaches treat each frame independently, the techniques herein embed relative timing information directly into the token representation so that an acknowledgment arriving 50us (microseconds) after a data frame yields a meaningfully different representation from an acknowledgment arriving after 500us. This ensures that the behavioral significance of timing variations is retained and carried into downstream processing.

The system further employs a self-supervised behavioral learning framework designed specifically for networking sequences. Instead of requiring labeled anomaly datasets, the model learns normal behavior using masked-token prediction tailored to protocol constraints. In particular, the masking strategy may use i) correlated masking, where masking a data frame triggers masking of its corresponding acknowledgment with a defined probability; ii) temporal masking, where contiguous sequences are masked to reveal burst-pattern dependencies; and iii) state-aware masking, where tokens whose removal would violate protocol validity are never masked. Through these constraints, the model internalizes both local dependencies, such as relationships between data and acknowledgment frames, and long-range behavioral patterns that unfold over minutes, all without manual labeling or supervision.

Anomaly detection in these techniques is performed through analysis of sequence likelihood derived from attention-based modeling of the behavioral tokens. For each observed sequence, the system computes conditional token probabilities representing the likelihood of each token given the preceding tokens, attention entropy measuring whether the model’s attention is concentrated or diffuse, and behavioral perplexity representing the exponential of the average negative log-likelihood across the sequence. The techniques herein also provide “perplexity gradients,” which measure the rate at which perplexity changes over time. For instance, sharp increases in perplexity gradients may indicate acute anomalies, such as authentication failures, whereas gradual increases correspond to slow-developing degradation conditions, such as increasing interference or progressive rate-adaptation oscillations.

Notably, a transformer architecture used herein employs a multi-scale temporal attention hierarchy that concurrently processes behaviors unfolding at different timescales. Micro-attention layers analyze microsecond-scale interactions at the protocol level, meso-attention layers capture millisecond-scale behavioral sequences such as retransmission bursts, and macro-attention layers model application-level behaviors unfolding over seconds or minutes. Each temporal scale uses a different positional encoding strategy (e.g., absolute encodings at the micro scale, relative encodings at the meso scale, and learned positional embeddings at the macro scale), allowing the model to simultaneously capture precise timing relationships and flexible, long-range behavioral patterns.

Through analysis of attention-weight distributions, the techniques herein may also perform behavioral grammar induction, allowing inference of implicit syntactic, semantic, and pragmatic rules governing client behavior. By identifying which tokens consistently attend to one another, the model discovers syntactic rules defining permissible sequences of protocol actions, semantic patterns representing meaningful behavioral phases such as authentication or idle periods, and pragmatic constraints reflecting context-dependent variations in behavior. For example, the model may naturally learn that power-save exit tokens strongly attend to subsequent data-burst tokens, capturing the implicit behavioral grammar that active transmission follows wake events. These induced grammars allow the system to classify behavior and also to predict the most likely future tokens of a sequence based on past context.

According to one or more embodiments herein, the techniques herein may predict future behavioral evolution using conditional sequence generation techniques. When confronted with partial sequences showing anomalous or emerging anomalous characteristics, the model generates multiple possible continuations, each evaluated and ranked by sequence likelihood. This enables failure prediction by identifying continuations that lead to expected disconnection events, root-cause inference by identifying early tokens with the largest influence on predicted failure outcomes, and intervention planning by suggesting parameter adjustments likely to prevent an undesirable trajectory. The continuation generation may, in one embodiment, illustratively use beam-search constrained by learned behavioral grammars, allowing the model to explore anomalous futures while maintaining protocol validity.

The techniques herein may also incorporate a cross-client behavioral transfer mechanism that uses attention-based similarity metrics to share behavioral knowledge across clients. That is, each client’s behavior may be represented as a behavioral fingerprint derived from its sequence embeddings. When a new client connects, the system computes attention weights between the new client’s initial token sequences and existing fingerprints, identifies the most behaviorally similar clients, and transfers relevant behavioral patterns weighted by these similarity scores. This enables immediate anomaly detection for previously unseen devices without requiring a dedicated per-client training period.

Moreover, to extend behavioral modeling across devices and network infrastructure while preserving privacy, the system may use a federated behavioral learning framework. Under this approach, access points share behavioral knowledge without exchanging any raw client events. Each access point generates behavioral embeddings, anomaly signatures describing detected anomalies, and grammar updates reflecting new or refined behavioral rules. Before transmission, these updates may undergo differential-privacy transformations to ensure that individual client behaviors cannot be reconstructed, while still allowing the network as a whole to improve its collective behavioral understanding.

Illustratively, the neural engine herein may process behavioral tokens in a streaming fashion, maintaining constant memory usage regardless of the client session length. The architecture supports online learning during normal operation, real-time inference with bounded latency, and graceful degradation under constrained computational resources. In general, the techniques herein may interface with existing wireless control-plane mechanisms to augment traditional anomaly-detection approaches by adding contextual behavioral intelligence to existing metrics-based methods.

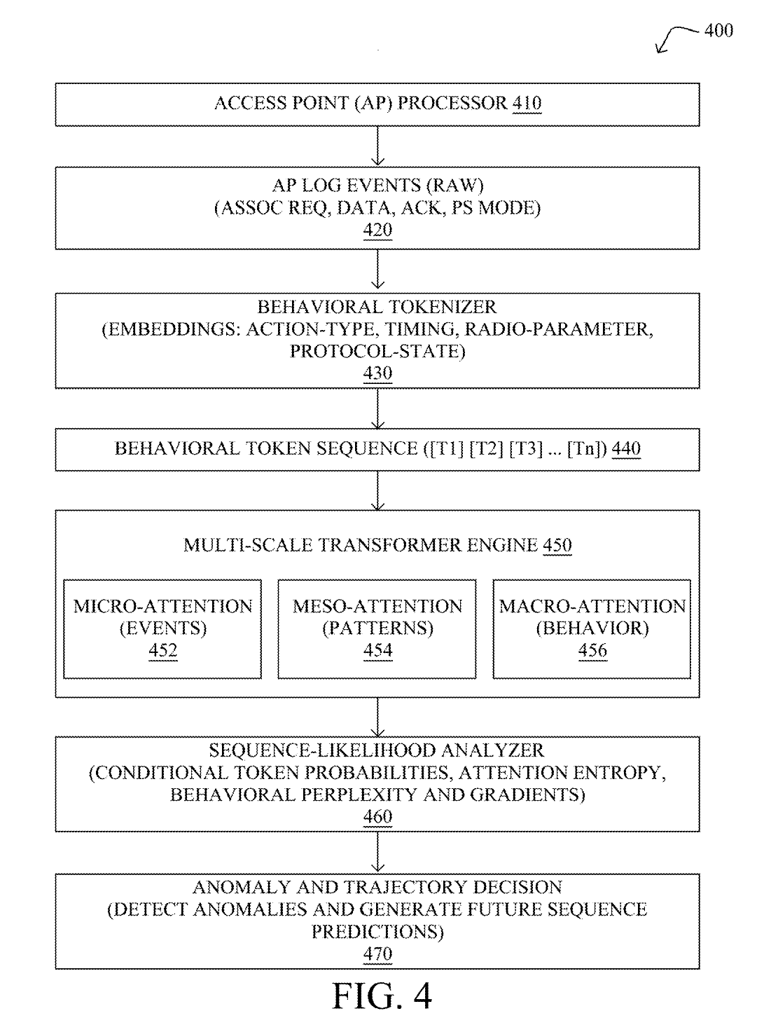

FIG. 4 illustrates an example behavioral-sequence processing pipeline (pipeline 400) implemented within an illustrative access point herein. As shown, the access point processor 410 receives raw access-point log events 420, including association requests, data frames, acknowledgment frames, power-save state transitions, and other client interaction events. These raw events are provided to a behavioral tokenizer 430 configured to convert each event into a behavioral token representation. The tokenizer generates token embeddings using multiple embedding dimensions, including action-type embeddings representing frame types and management actions, timing embeddings representing inter-frame spacing and duration patterns, radio-parameter embeddings encoding modulation schemes, spatial-stream counts, and transmit-power levels, and protocol-state embeddings capturing power-save modes, aggregation states, and protection-mechanism attributes. The tokenized events form a behavioral token sequence 440 supplied to a multi-scale transformer engine 450.

The multi-scale transformer engine 450 includes multiple attention layers operating at different temporal resolutions, including micro-attention layers 452 that process microsecond-level protocol events, meso-attention layers 454 that capture millisecond-scale retransmission and interaction patterns, and macro-attention layers 456 that model behavioral relationships occurring over seconds or minutes (or more). Each attention scale applies a different positional encoding strategy to preserve appropriate temporal structure. The output of the multi-scale transformer is provided to a sequence-likelihood analyzer 460 configured to compute conditional token probabilities, attention-entropy measures, behavioral perplexity, and perplexity gradients over time. Based on these likelihood metrics, an anomaly-and-trajectory decision module 470 detects anomalies or emerging degradation conditions and may further generate predicted behavioral continuations representing likely future outcomes for the client’s connection state, as described above.

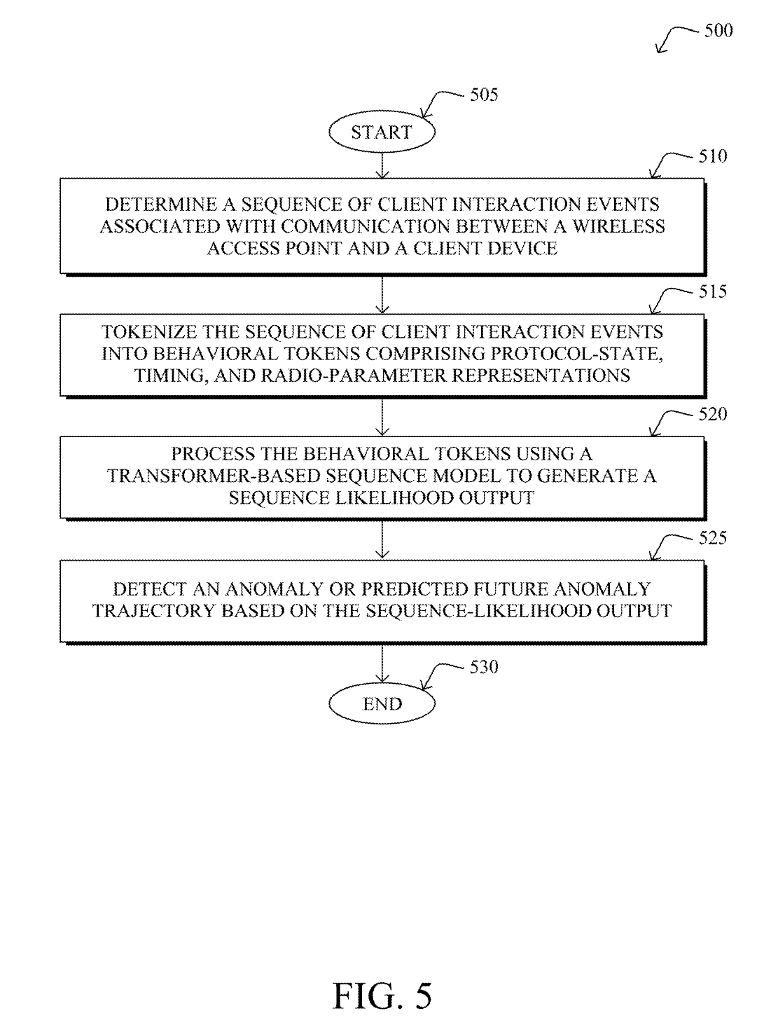

In closing, FIG. 5 illustrates an example simplified procedure for behavioral sequence modeling for predictive client anomaly detection in wireless networks in accordance with one or more embodiments described herein. For example, a non-generic, specifically configured device (e.g., device 200, an apparatus, such as a controller or a wireless access point locally) may perform procedure 500 (e.g., a method) by executing stored instructions (e.g., process 248). Procedure 500 may start at step 505 and continues to step 510, where, as described in greater detail above, the techniques herein determine a sequence of client interaction events associated with communication between a wireless access point and a client device. Then, in step 515, the techniques herein may tokenize the sequence of client interaction events into behavioral tokens comprising protocol-state, timing, and radio-parameter representations, such as by converting access point log entries into a structured behavioral language using a log-aware tokenizer as detailed above.

In step 520, the techniques herein may then process the behavioral tokens using a transformer-based sequence model to generate a sequence-likelihood output, such as applying multi-scale temporal attention spanning microsecond-level protocol events to multi-minute behavioral sequences. Note that in one embodiment, the device, as the wireless access point, may receive the transformer-based sequence model from a controller or a cloud service. In another embodiment, the device, as the wireless access point, may build the transformer-based sequence model based on local observations. In still a further embodiment, the transformer-based sequence model may be derived from federated learning performed across a plurality of wireless access points. Further, in one embodiment, regardless of origin, the techniques herein may also update the transformer-based sequence model based on local observations at the wireless access point.

In step 525, the techniques herein may detect (e.g., and mitigate) an anomaly or predicted future anomaly trajectory based on the sequence-likelihood output. For instance, the techniques herein may compute an anomaly score based on conditional token probabilities, attention entropy, sequence perplexity of the behavioral tokens, and so on. Also, in one embodiment, the techniques herein may identify root-cause tokens by computing token-level contribution scores to the anomalies.

Procedure 500 concludes at step 530, notably with the option to continue monitoring client interactions to determine behavioral sequence anomalies, and so on.

The techniques described herein, therefore, provide for behavioral sequence modeling for predictive client anomaly detection in wireless networks. In particular, the techniques herein provide predictive capabilities that enable early detection and proactive intervention before user-perceived failures occur. By differentiating between legitimate behavioral adaptations and actual service degradation, the system reduces false positives, ensuring administrators are not overwhelmed by unnecessary alerts. Additionally, the techniques herein support root cause analysis by identifying the causal event sequences leading to anomalies rather than merely detecting isolated symptoms. Moreover, the techniques herein further allows for device heterogeneity handling, adapting seamlessly to diverse client behaviors without requiring manual configuration or device-specific tuning. Through privacy-preserving intelligence sharing using federated learning, the system improves detection accuracy across distributed networks while safeguarding individual user privacy. Finally, the architecture achieves computational efficiency by employing streaming inference methods with bounded memory and latency requirements, enabling real-time deployment even in resource-constrained environments.

According to one or more embodiments of the present disclosure, an illustrative method herein may comprise: determining, by a device, a sequence of client interaction events associated with communication between a wireless access point and a client device; tokenizing, by the device, the sequence of client interaction events into behavioral tokens comprising protocol-state, timing, and radio-parameter representations; processing, by the device, the behavioral tokens using a transformer-based sequence model to generate a sequence-likelihood output; and detecting, by the device, an anomaly or predicted future anomaly trajectory based on the sequence-likelihood output.

In one embodiment, the method further comprises: receiving, at the device as the wireless access point, the transformer-based sequence model from a controller or a cloud service.

In one embodiment, the transformer-based sequence model is derived from federated learning performed across a plurality of wireless access points.

In one embodiment, the method further comprises: building, by the device as the wireless access point, the transformer-based sequence model based on local observations of the client device.

In one embodiment, the method further comprises: updating the transformer-based sequence model based on local observations at the wireless access point.

In one embodiment, tokenizing comprises: converting access point log entries into a structured behavioral language using a log-aware tokenizer.

In one embodiment, processing comprises: applying multi-scale temporal attention spanning microsecond-level protocol events to multi-minute behavioral sequences.

In one embodiment, detecting comprises: computing an anomaly score based on one or more of conditional token probabilities, attention entropy, or sequence perplexity of the behavioral tokens.

In one embodiment, the method further comprises: mitigating the anomaly or the predicted future anomaly trajectory.

In one embodiment, detecting comprises: identifying root-cause tokens by computing token-level contribution scores to the anomaly or the predicted future anomaly trajectory.

According to one or more additional embodiments of the present disclosure, an illustrative apparatus (e.g., device, controller, wireless access point, etc.) herein may comprise: one or more network interfaces to communicate on a wireless network; a processor configured to execute one or more processes; and a memory configured to store a process that is executable on the apparatus, the process comprising: determining a sequence of client interaction events associated with communication between a wireless access point and a client device; tokenizing the sequence of client interaction events into behavioral tokens comprising protocol-state, timing, and radio-parameter representations; processing the behavioral tokens using a transformer-based sequence model to generate a sequence-likelihood output; and detecting an anomaly or predicted future anomaly trajectory based on the sequence-likelihood output.

According to one or more additional embodiments of the present disclosure, an illustrative tangible, non-transitory, computer-readable medium herein may store program instructions that cause a device to execute a process comprising: determining a sequence of client interaction events associated with communication between a wireless access point and a client device; tokenizing the sequence of client interaction events into behavioral tokens comprising protocol-state, timing, and radio-parameter representations; processing the behavioral tokens using a transformer-based sequence model to generate a sequence-likelihood output; and detecting an anomaly or predicted future anomaly trajectory based on the sequence-likelihood output.

Illustratively, the techniques described herein may be performed by hardware, software, and/or firmware, (e.g., an “apparatus”) such as in accordance with the predictive wireless networking process, process 248, e.g., a “method”), which may include computer-executable instructions executed by the processor(s) 220 to perform functions relating to the techniques described herein, e.g., in conjunction with corresponding processes of other devices in the computer network as described herein. In addition, the components herein may be implemented on a singular device or in a distributed manner, in which case the combination of executing devices can be viewed as their own singular “device” for purposes of executing the process (e.g., process 248).

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
determining, by a device, a sequence of client interaction events associated with communication between a wireless access point and a client device;
tokenizing, by the device, the sequence of client interaction events into behavioral tokens comprising protocol-state, timing, and radio-parameter representations;
processing, by the device, the behavioral tokens using a transformer-based sequence model to generate a sequence-likelihood output; and
detecting, by the device, an anomaly or predicted future anomaly trajectory based on the sequence-likelihood output.

2. The method of claim 1, further comprising:
receiving, at the device as the wireless access point, the transformer-based sequence model from a controller or a cloud service.

3. The method of claim 1, wherein the transformer-based sequence model is derived from federated learning performed across a plurality of wireless access points.

4. The method of claim 1, further comprising:
building, by the device as the wireless access point, the transformer-based sequence model based on local observations of the client device.

5. The method of claim 1, further comprising:
updating the transformer-based sequence model based on local observations at the wireless access point.

6. The method of claim 1, wherein tokenizing comprises:
converting access point log entries into a structured behavioral language using a log-aware tokenizer.

7. The method of claim 1, wherein processing comprises:
applying multi-scale temporal attention spanning microsecond-level protocol events to multi-minute behavioral sequences.

8. The method of claim 1, wherein detecting comprises:
computing an anomaly score based on one or more of conditional token probabilities, attention entropy, or sequence perplexity of the behavioral tokens.

9. The method of claim 1, further comprising:
mitigating the anomaly or the predicted future anomaly trajectory.

10. The method of claim 1, wherein detecting comprises:
identifying root-cause tokens by computing token-level contribution scores to the anomaly or the predicted future anomaly trajectory.

11. An apparatus, comprising:
one or more network interfaces to communicate on a wireless network;
a processor configured to execute one or more processes; and
a memory configured to store a process that is executable on the apparatus, the process comprising:
determining a sequence of client interaction events associated with communication between a wireless access point and a client device;
tokenizing the sequence of client interaction events into behavioral tokens comprising protocol-state, timing, and radio-parameter representations;
processing the behavioral tokens using a transformer-based sequence model to generate a sequence-likelihood output; and
detecting an anomaly or predicted future anomaly trajectory based on the sequence-likelihood output.

12. The apparatus of claim 11, wherein the process further comprises:
receiving, as the wireless access point, the transformer-based sequence model from a controller or a cloud service.

13. The apparatus of claim 11, wherein the transformer-based sequence model is derived from federated learning performed across a plurality of wireless access points.

14. The apparatus of claim 11, wherein the process further comprises:
building, as the wireless access point, the transformer-based sequence model based on local observations of the client device.

15. The apparatus of claim 11, wherein the process further comprises:
updating the transformer-based sequence model based on local observations at the wireless access point.

16. The apparatus of claim 11, wherein tokenizing comprises:
converting access point log entries into a structured behavioral language using a log-aware tokenizer.

17. The apparatus of claim 11, wherein processing comprises:
applying multi-scale temporal attention spanning microsecond-level protocol events to multi-minute behavioral sequences.

18. The apparatus of claim 11, wherein detecting comprises:
computing an anomaly score based on one or more of conditional token probabilities, attention entropy, or sequence perplexity of the behavioral tokens.

19. The apparatus of claim 11, wherein the process further comprises:
mitigating the anomaly or the predicted future anomaly trajectory.

20. A tangible, non-transitory, computer-readable medium storing program instructions that cause a device to execute a process comprising:
determining a sequence of client interaction events associated with communication between a wireless access point and a client device;
tokenizing the sequence of client interaction events into behavioral tokens comprising protocol-state, timing, and radio-parameter representations;
processing the behavioral tokens using a transformer-based sequence model to generate a sequence-likelihood output; and
detecting an anomaly or predicted future anomaly trajectory based on the sequence-likelihood output.
